(19) United States
(12) Patent Application Publication
(10) Pub. No.: US 2023/0272828 A1
(43) Pub. Date: Aug. 31, 2023

(54) DISK BRAKE DEVICE AND BRAKE PAD

(71) Applicants: VOLKSWAGEN AKTIENGESELLSCHAFT, Wolfsburg (DE); MANN+HUMMEL GMBH, Ludwigsburg (DE)

(72) Inventors: Kai Götz, Wolfsburg (DE); Frank Stebner, Braunschweig (DE); Tobias Wörz, Leutenbach (DE); Benedikt Weller, Steinheim (DE); Steffen Pfannkuch, Ludwigsburg (DE)

(21) Appl. No.: 18/248,655

(22) PCT Filed: Oct. 12, 2021
(86) PCT No.: PCT/EP2021/078149

§ 371 Date: Apr. 11, 2023

(30) Foreign Application Priority Data
Oct. 13, 2020 (DE) 102020126890.4

(51) Int. Cl. F16D 65/00; F16D 55/22; F16D 65/12; F16D 65/092

(52) U.S. Cl. CPC F16D 65/0031; F16D 55/22; F16D 65/128; F16D 65/092; F16D 2065/1328

(57) ABSTRACT

A disk brake device for a vehicle, that includes an internally-ventilated or solid brake disk. The internally-vented brake disk is configured having ventilation openings on the vehicle side, on the radial inside in the region of a brake disk chamber, which ventilation openings are fluidically connected to cooling channels in the interior of the brake disk. The solid brake disk is configured without such ventilation openings and with cooling channels. A brake caliper fitting is configured over the brake disk with a brake pad arranged on both sides of the brake disk. The brake disk device is configured with a brake dust filter housing that encompasses the brake disk on the radial outside and is arranged downstream of the brake caliper, together with the brake pads. The disk brake device has at least one means for forced guidance of brake dust.

### RELATED APPLICATIONS

The present application claims priority to international Patent Application No. PCT/EP2021/078149 to Kai Gotz, et al., titled “Disk Brake Device And Brake Pad”, filed Oct. 12, 2021, which claims priority to German Patent App. No. DE 10 2020 126 890.4, filed Oct. 13, 2020, the contents of each being incorporated by reference in their entirety herein.

### FIELD OF TECHNOLOGY

The present disclosure relates to a disk brake device for a vehicle, to a vehicle comprising such a disk brake device, and to a brake pad for such a disk brake device, which each allow contamination of the environment by brake dust to be reduced.

### BACKGROUND

Brake dust, which is caused by abraded particles from brake pads, in particular in the case of disk brakes, contaminates the environment. It is therefore desirable to reduce the contamination of the environment from brake dust emission.

A disk brake for vehicle wheels is known from DE 39 34 422 A1, to which a container is attached, in which arising abraded particles, also referred to as brake dust, is able to collect. This container is to be so large as to accommodate abraded brake particles caused during the service life of a pair of brake pads. The container is made of a housing encompassing a portion of the brake disk and a filter arranged between the housing and the brake disk. The filter contains means that cause the abraded brake particles entrained by the air flow to be introduced into the filter.

EP 2 102 522 B1 describes a brake dust collection device for a disk brake, wherein the disk brake comprises a brake disk and a brake caliper extending across the latter. The brake dust collection device comprises a housing designed to extend across a portion of the brake disk, directly adjoining the brake caliper, viewed in the main direction of rotation of the brake disk.

US2018/0031059 A1 shows a braking device comprising a covering in a region that, along the circumference, is not covered by the brake caliper and the brake pads, that is a covering that is only situated upstream and downstream from the brake caliper in the direction of rotation.

DE 103 36 984 A1 shows an enclosure of the brake caliper including brush seals, but no flow guidance for guiding abraded brake particles.

DE 10 2019 133 722 A1 shows a flushing air supply and discharge for discharging brake dust and other types of dust in the immediate vicinity of the brake pad.

In practice, it was found that these solutions do not sufficiently prevent the release of brake dust into the environment. This problem is addressed by the invention described hereafter.

### SUMMARY

Aspects of the present disclosure relate to a disk brake device for a vehicle, to a vehicle comprising a disk brake device, and to a brake pad, in particular for use in a disk brake device, according to the independent claims. Further embodiments are provided in the dependent claims.

A disk brake device for a vehicle may be configured with an internally vented or a solid brake disk, wherein the internally vented brake disk, on the vehicle side, has vent openings on the radial inside in the region of a brake disk bell, which are connected, in terms of flow, to cooling channels in the interior of the brake disk, and wherein the solid brake disk does not have such vent openings including cooling channels, and comprises a brake caliper, which extends across the brake disk and has a respective brake pad arranged on the two sides of the brake disk, wherein a brake dust filter housing, which encompasses the brake disk on the radial outside and is arranged downstream from the brake caliper, including the brake pads, viewed in a main direction of rotation of the brake disk, is assigned to the brake disk device, the stated object is achieved in that the disk brake device comprises at least one means for the forced guidance of brake dust. The brake disk furthermore comprises two axially oriented friction surfaces that face away from one another.

The measure for avoiding the release of brake dust into the environment is accordingly not limited to the aforementioned conventional brake dust filter housing assigned to the disk brake device, but comprises at least one means for the forced guidance of brake dust into, for example, the aforementioned brake dust filter housing, so as to prevent, at least, however, to effectively further minimize, brake dust from being released into the environment, the aforementioned means for forced guidance according to the invention being formed by the disk brake device itself.

In some examples, a disk brake device for a vehicle is disclosed, comprising a brake disk having a first axially oriented friction surface and a second axially oriented friction surface facing away from the first friction surface, and comprising a brake caliper, which extends across the brake disk and comprises a first brake pad assigned to the first friction surface and a second brake pad assigned to the second friction surface, wherein the disk brake device comprises a brake dust filter housing, which encompasses the brake disk on the radial outside and has a receiving opening, and which is arranged downstream from the brake caliper, viewed in a main direction of rotation of the brake disk, wherein the brake disk device comprises a means for the forced guidance of brake dust, wherein the means for the forced guidance of brake dust, proceeding from at least one of the first and second brake pads, extends in such a way radially inwardly over the accordingly assigned friction surface of the brake disk in the direction of an inner edge of this friction surface that brake dust, exiting radially inwardly between the at least one of the first and second brake pads and the brake disk is guided, along the friction surface assigned to the one of the first and second brake pads, along at least a partial flow path of the brake dust, to the receiving opening of the brake dust filter housing.

In some examples, a vehicle is disclosed comprising a disk brake device as described herein.

A further aspect of the present disclosure relates to a brake pad for a disk brake device, which comprises a brake pad back plate and a friction lining attached to the brake pad back plate. A means for the forced guidance of brake dust can be connected to the brake pad according to the invention. This allows the means for the forced guidance of brake dust to be replaced with the scope of routine service performed on the brake pads, which in particular is also a convenient solution for eliminating damage to the means for the forced guidance of brake dust.

In some examples, the means for forced guidance can be a guide plate or a brake dust guidance element, which, in an assembly arrangement of the brake pad, extends away from the friction lining in the radial direction.

For example, the means for the forced guidance of brake dust is designed in one piece with the brake pad back plate. This allows the forced guidance of brake dust provided according to the invention to be implemented in a cost-effective and simple manner. The costs for producing a brake pad thus modified hardly differ from those for producing a conventional brake pad.

Furthermore, the guide plate or brake dust guidance element, on the inner circumference thereof, can comprise an edge that is designed at least in sections in a circular arc-shaped manner, having a radius of curvature that, in an assembled state, corresponds to a diameter of the brake disk bell.

### BRIEF DESCRIPTION OF THE DRAWINGS

Aspects of the present disclosure are described hereafter in more detail based on the exemplary embodiments that are schematically illustrated in the drawings. However, the invention is not limited to these, but covers all embodiments defined by the patent claims. In the drawings:

FIG. 1 shows a highly schematic illustration of a vehicle equipped with a disk brake device according to some aspects of the present disclosure;

FIG. 2 shows a perspective illustration of a wheel carrier of the vehicle according to FIG. 1 comprising a conventional disk brake device as is known in the art;

FIG. 3a shows a perspective individual illustration of the disk brake device comprising a configuration for the forced guidance of brake dust according to some aspects of the present disclosure;

FIG. 3b shows a schematic illustration of the operating principle of the aforementioned configuration for the forced guidance of brake dust according to FIG. 3a, according to some aspects of the present disclosure;

FIG. 3c shows a supplemental sectional illustration of the disk brake device with respect to the aforementioned operating principle of the aforementioned configuration for the forced guidance of brake dust according to FIG. 3a, according to some aspects of the present disclosure;

FIG. 4a shows a perspective illustration of the disk brake device, including the wheel carrier, comprising a configuration for the forced guidance of brake dust according to one variant of the present disclosure;

FIG. 4b shows a sectional illustration of the disk brake device according to FIG. 4a, according to some aspects of the present disclosure;

FIG. 5 shows a perspective individual illustration of the disk brake device for the forced guidance of brake dust, according to some aspects of the present disclosure; and

FIG. 6 shows a perspective individual illustration of the brake pad according to some aspects of the present disclosure.

### DETAILED DESCRIPTION

In various aspects disclosed herein, brake dust that is abraded from a brake pad as a result of friction on a friction surface of the brake disk can be guided along a defined flow path, in particular deliberately from the point of origin along the defined and at least partially guided flow path to a filter, in which the abraded brake dust can be separated. As a result of the guidance of the brake dust, the brake dust filter can have a more compact design. The entire disk brake device can have a more compact design since the brake dust no longer has to be removed in a manner that is distributed over the entire brake disk, but is deliberately guided directly from the point of origin to a brake dust filter in a brake dust filter housing. In the process, flow paths that are already present in and on a disk brake device, such as cooling air flow paths, can be integrated in the transport.

In some examples, the means for the forced guidance of brake dust, proceeding from the at least one of the first and second brake pads, extends radially inwardly over the accordingly assigned friction surface of the brake disk to an inner edge of this friction surface.

In this way, the brake dust can be inwardly guided along a brake disk surface, and it is possible to prevent the brake dust from distributing between a brake pad and an inner structure in an uncontrolled manner and from reaching the environment. Furthermore, the brake dust can be deliberately guided close to possibly already existing structures so as to deliberately guide the brake dust to a brake dust filter.

In some examples, the brake disk is an internally vented brake disk, wherein the brake disk, on the vehicle side, has vent openings on the radial inside in the region of a brake disk bell, which are connected, in terms of flow, to cooling channels in the interior of the brake disk, wherein the means for forced guidance comprises a guide plate, which extends radially along the first friction surface of the brake disk, at which the vent openings are present, between the first brake pad and the vent openings and, spaced axially apart from the first friction surface of the brake disk, reaches a region of the vent openings in such a way that, proceeding from the first brake pad, a defined flow path for the brake dust is formed by way of the guide plate, through the vent openings and cooling channels of the brake disk, to the receiving opening of the brake dust filter housing.

In this way, the brake dust can be guided close to the inner channels of the internally vented brake disk, and the channels of the internally vented brake disk can be used not only as cooling channels, but also as guide channels for the brake dust. A plate, in some examples, shall be understood to mean a structure that is able to guide the brake dust, in particular to the entrance of the cooling channel or cooling channels. The guide plate does not necessarily have to be made of metal. Even if higher temperatures are expected, it is possible, for example, to use thermally stable plastic materials for manufacturing corresponding molded parts.

In some examples, the guide plate ends in the region of the vent openings may be configured such that, in addition to the guidance of the brake dust into or to the vent openings, air flow from the outside into the vent openings is ensured.

Thus, during operation of the disk brake device, an air flow develops through the channels of the internally vented brake disk, and that this flow is utilized to also guide the brake dust to the brake dust filter. For this purpose, the brake dust is guided from the brake pad into a region in which the cooling air flow prevails, so that the brake dust fed by the guide plate is entrained by the cooling flow. This flow is then deliberately fed to the brake dust filter after exiting the cooling channels.

In some examples, the guide plate, in the region of the vent openings, may include a deflection edge that is bent toward the brake disk and guided around an inner edge of the friction surface. The brake dust can thus already be guided around the edge of the brake disk, into the vicinity of the inflow opening of the cooling channels. It shall be understood that further guide structures can also be provided at the exit of the cooling channels, provided that the brake dust filter does not directly adjoin there. When positioning receiving structures for brake dust-laden cooling air at the exits of the cooling channels, it is possible to take into consideration that the brake disk rotates during operation, and the receiving structures, for example also an inflow opening of a brake dust filter, can be offset to the rear in the direction of rotation so as to account for the fact that the brake disk continues to rotate as the brake dust-laden air flows through.

In some examples, the guide plate may be configured, at least in sections, on the inner circumference thereof so as to follow a progression of the brake disk bell, wherein the guide plate, on the inner circumference thereof, in particular comprises a circular arc-shaped edge. In this way, the distance between the guide plate and the brake disk can be kept approximately constant, resulting in a uniform flow cross-section. The brake dust can thus be simultaneously guided close to multiple cooling channel openings, so as then be fed to the brake dust filter downstream from cooling channels.

In some examples, the guide plate, together with the brake caliper, the brake disk, and the components surrounding the brake dust filter housing, forms a substantially sealed brake dust guidance and venting system. In this way, it can be ensured that no brake dust reaches the environment. The guide plate can also be provided on the other sides of the brake pad, so that brake dust exiting there can also be removed. For this purpose, the edges of the guide plate can be bent in the direction of the friction surface of the brake disks so as to form channels in this way, through which the brake dust can be guided. Potential gaps between the guide plate and the brake disk can be kept so small that these are not critical in terms of flow. When the air flowing into the cooling channel meets the conditions of the Bernoulli effect, a vacuum can be generated by a channel that is formed by the brake disk and the guide plate, which not only suctions the brake dust in the direction of the entrance of the cooling channel, but also prevents brake dust from reaching the environment through the gap formed between the guide plate and the brake disk.

In some examples, the first brake pad may include a brake pad back plate, and the guide plate may be fixedly connected to the brake pad back plate, and in particular designed in one piece with the brake pad back plate of the first brake pad. The guide plate can thus be automatically exchanged during a brake pad replacement. The guide plate may include brake dust absorption surfaces, which can be dimensioned so as to be essentially saturated at the end of the service life of the brake pads.

In some examples, the first brake pad may include a friction lining, and the guide plate is fixedly connected to the friction lining. In this way, the guide plate can be adapted to the outer geometry of the friction lining, and a seal can be established with respect to the friction lining.

In some examples, the guide plate may be fixedly connected to the brake caliper. The guide plate can thus remain on the disk brake device during a brake pad replacement. This is in particular relevant in cases in which the guide plate remains essentially unchanged during operation, and in particular does not wear or is not loaded with dirt in a manner that limits the function thereof.

In some examples, the means for forced guidance may include a brake dust guidance element, which, when installed, forms a housing and, on the second friction surface of the brake disk, extends away from the second brake pad and in the direction of an inner edge of the second friction surface of the brake disk. On the second friction surface, the brake dust arising between the second brake pad and the second friction surface, can thus be reliably retained, in particular in a direction facing away from the brake caliper. Brake dust exiting on the brake caliper side can already be prevented from spreading further by the brake caliper.

In some examples, the brake dust guidance element may extend on the second friction surface of the brake disk, radially away from the second brake pad, to an inner edge of the second friction surface of the brake disk. In this way, it can be ensured that no brake dust reaches the environment. The brake dust guidance element can be provided on both sides of the brake disk, so that brake dust exiting there can also be removed. For this purpose, the edges of the brake dust guidance element can be bent in the direction of the friction surfaces of the brake disks so as to form channels in this way, through which the brake dust can be guided. Potential gaps between the brake dust guidance element and the brake disk can be kept so small that these are not critical in terms of flow.

In some examples, the second brake pad may include a brake pad back plate, and the brake dust guidance element is fixedly connected to the brake pad back plate, and in particular configured as one piece with the brake pad back plate of the second brake pad. The brake dust guidance element can thus be automatically exchanged during the brake pad replacement. The brake dust guidance element can comprise brake dust absorption surfaces, which can be dimensioned so as to be essentially saturated at the end of the service life of the brake pads.

In some examples, the second brake pad may include a friction lining, and the brake dust guidance element is fixedly connected to the friction lining. In this way, the brake dust guidance element can be adapted to the outer geometry of the friction lining, and a seal can be established with respect to the friction lining.

In some examples, the brake dust guidance element may be fixedly connected to the brake caliper. The brake dust guidance element can thus remain on the disk brake device during a brake pad replacement. This is in particular relevant in cases in which the brake dust guidance element remains essentially unchanged during operation, and in particular does not wear or is not loaded with dirt in a manner that limits the function thereof.

In some examples, the means for forced guidance may include a further brake dust guidance element, which, when installed, forms a housing and, on the first friction surface of the brake disk, extends radially away from the first brake pad in the direction of an inner edge of the first friction surface of the brake disk. In this way, a targeted removal of the brake dust by way of a brake dust guidance element, as described above, can be achieved on both sides of the brake disk.

In some examples, the further brake dust guidance element, which, when installed, forms a housing, extends on the first friction surface of the brake disk radially away from the first brake pad, to an inner edge of the first friction surface of the brake disk. In this way, a channel, which extends at least partially along the circumference, can be formed on both sides of the brake disk by the brake dust guidance element and the friction surface of the brake disk.

In some examples, a vehicle is disclosed that includes the disk brake devices disclosed herein. In this way, the emission of harmful brake disk can be reduced in vehicles.

In some examples, a brake pad is provided for a disk brake device, wherein the brake pad comprises a brake pad back plate, a friction lining attached to the brake pad back plate, and a means for the forced guidance of brake dust, the means for the forced guidance of brake dust being connected to the brake pad. The means for the forced guidance of brake dust can thus be automatically exchanged during the brake pad replacement. The means for the forced guidance of brake dust can comprise brake dust absorption surfaces, which can be dimensioned so as to be essentially saturated at the end of the service life of the brake pads. Furthermore, the means for the forced guidance of brake dust can be adapted to the outer geometry of the friction lining, and a seal in terms of flow can be established with respect to the friction lining.

In some examples, the brake pad may be configured and adapted for the disk brake device configurations disclosed herein. In this way, a disk brake device which has reduced harmful substance emissions can be provided.

In some examples, the means for forced guidance, in an assembly arrangement of the brake pad, extends away from the friction lining in the radial direction, and in particular away toward the inside. In this way, the brake dust can be inwardly guided along a brake disk surface, and it is possible to prevent the brake dust from inadvertently distributing between a brake pad and an inner structure and from reaching the environment. Furthermore, the brake dust can be deliberately guided close to possibly already existing structures so as to deliberately guide the brake dust to the brake dust filter.

In some examples, the means for the forced guidance of brake dust may be configured as one piece with the brake pad back plate. The means for the forced guidance of brake dust can thus be automatically exchanged during the brake pad replacement. The means for the forced guidance of brake dust can comprise brake dust absorption surfaces, which can be dimensioned so as to be essentially saturated at the end of the service life of the brake pads.

In some examples, the brake pad comprises a friction lining, and the means for the forced guidance of brake dust is fixedly connected to the friction lining. In this way, the means for the forced guidance of brake dust can be adapted to the outer geometry of the friction lining, and a seal can be established with respect to the friction lining.

In some examples, the means for the forced guidance of brake dust, on the inner circumference thereof, comprises an at least sectionally circular arc-shaped edge. In this way, the distance between the means for the forced guidance of brake dust and the brake disk can be kept approximately constant, resulting in a uniform flow cross-section. The brake dust can thus be simultaneously guided close to multiple cooling channel openings, so as then be fed to the brake dust filter downstream from the cooling channels.

In some examples, the means for forced guidance, with respect to the aforementioned internally vented brake disk, is formed by a guide plate, which extends, on an axial side of the brake disk on which the vent openings are present, radially between the brake pad in question and the vent openings and, axially spaced from the friction surface, is connected on the one hand to the brake pad and/or the brake caliper, and on the other hand reaches into a region of the vent openings in such a way that, proceeding from the aforementioned brake pad, a defined flow path for the brake dust is formed through the vent openings and cooling channels of the brake disk, to a receiving opening of the aforementioned brake dust filter housing.

As a result of this measure, a conventionally present option for releasing brake dust into the environment, namely in the region between the brake pad in question and the vent openings, is prevented, or at least reduced to a minimum. Brake dust abraded from the brake pad is forcibly guided by the guide plate and, as a result of an air flow entering the vent openings, is suctioned into the vent openings for the purpose of cooling the brake disk, and is guided further through the cooling channels of the disk brake to the brake dust filter housing accommodating the brake dust. A plate can be made of metal or another suitable non-metallic material.

In some examples, the guide plate ends in the region of the vent openings such that, in addition to the guidance of the brake dust into the vent openings, an aforementioned air flow from the outside into the vent openings is ensured. This means that two flow channels that are separated from one another are created in the entrance region of the vent openings by the free end of the guide plate which is positioned in the entrance region of the vent openings, namely, on the one hand, for the aforementioned air flow and, on the other hand, for the brake dust, which combine to form a guide channel or the aforementioned cooling channel of the disk brake in the immediate entrance region of the vent openings.

So as to ensure reliable guidance in particular of the brake dust into the vent openings of the disk brake, the guide plate according to one example, in the region of the aforementioned vent openings, comprises a deflection edge that is bent toward the brake disk. Alternately and/or additionally, the guide plate may be configured at least in sections so as to follow a progression of the brake disk bell. By way of example, the guide plate, on the inner circumference thereof, can comprise an edge that is designed at least in sections in a circular arc-shaped manner. In other words, a radius of this edge corresponds to a radius of the brake disk bell. In this way, particularly effective sealing is achieved, while minimized gap losses.

So as to ensure a particularly effective forced guidance of the brake dust, in some examples, the guide plate, together with the components of the disk brake device and of the brake dust filter housing surrounding the same, forms a substantially sealed brake dust guidance and venting system, taking the rotating system of the disk brake device or the rotating brake disk into consideration. This results, for example, from the guide plate, on the edge side, comprising edge webs or bends that are brought close to the brake disk.

In some examples, the guide plate may be configured as one piece with a brake pad back plate of the brake pad. This allows the forced guidance of brake dust provided according to the invention to be implemented in a particularly cost-effective and simple manner. The costs for producing a brake pad thus modified hardly differ from those for producing a conventional brake pad.

In some examples, the means for forced guidance, with respect to the aforementioned internally vented brake disk, may be formed by a brake dust guidance element, which at least when installed forms a housing and extends, on the axial side of the brake disk on which the vent openings are not present, radially between the brake pad in question and the radially inner brake disk bell of the brake disk and is connected to the brake pad and/or the brake caliper.

In some examples, the brake dust guidance element can also be designed in one piece with a brake pad back plate of the brake pad, which likewise allows the forced guidance of brake dust to be provided in a particularly cost-effective manner. As a result of this measure, the option for releasing brake dust into the environment is prevented or minimized, namely on the side of the internally vented brake disk located opposite the vent openings in the region between the brake pad in question and the brake disk bell. Furthermore, it is thus achieved that brake dust is already collected at the point of origin, and is not disadvantageously released into the environment.

In some examples, the brake dust guidance element, in terms of flow, may be directly connected to the brake dust filter housing or directly adjoins the receiving opening thereof. For example, the brake dust guidance element is attached to the brake pad and/or the brake caliper.

In some examples, with respect to the internally vented brake disk, the disk brake device may include both a guide plate and a brake dust guidance element of the above-described kind, having the properties described accordingly above, whereby the release of brake dust into the environment is prevented particularly effectively, however is at least minimized more effectively than in the conventional manner.

With respect to the solid brake disk, which does not have vent openings including cooling channels, the means for forced guidance may be formed by a brake dust guidance element of the kind described herein, which may be arranged at least on one side, and for example on both sides, of the brake disk and, at least when installed, forms a housing, and which in each case extends radially between the brake pad in question and the radially inner brake disk bell of the brake disk and is connected to the brake pad and/or the brake caliper. In this case as well, the brake dust guidance element may be attached to the brake pad and/or the brake caliper.

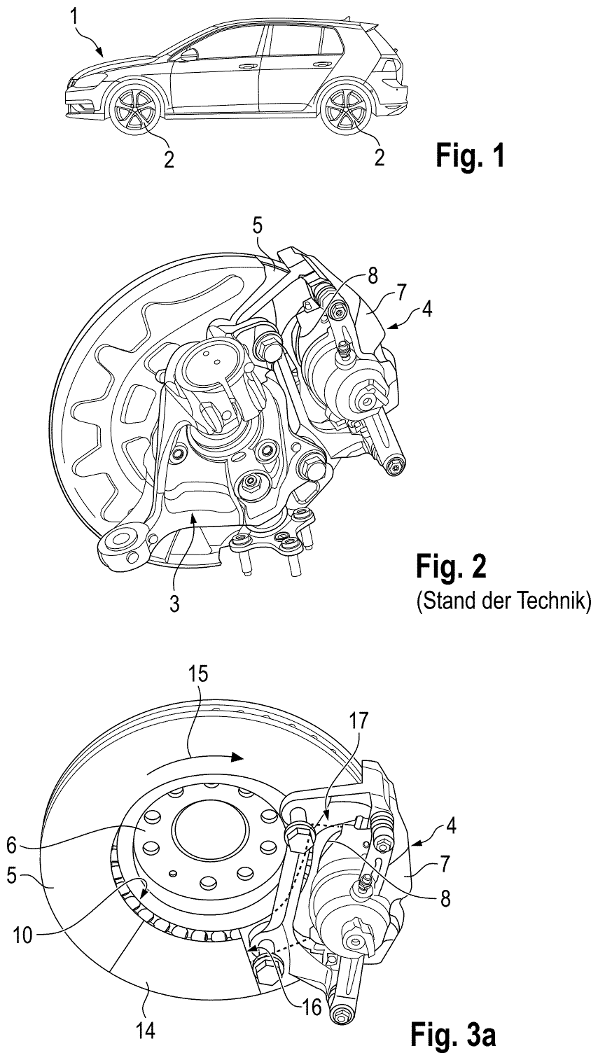

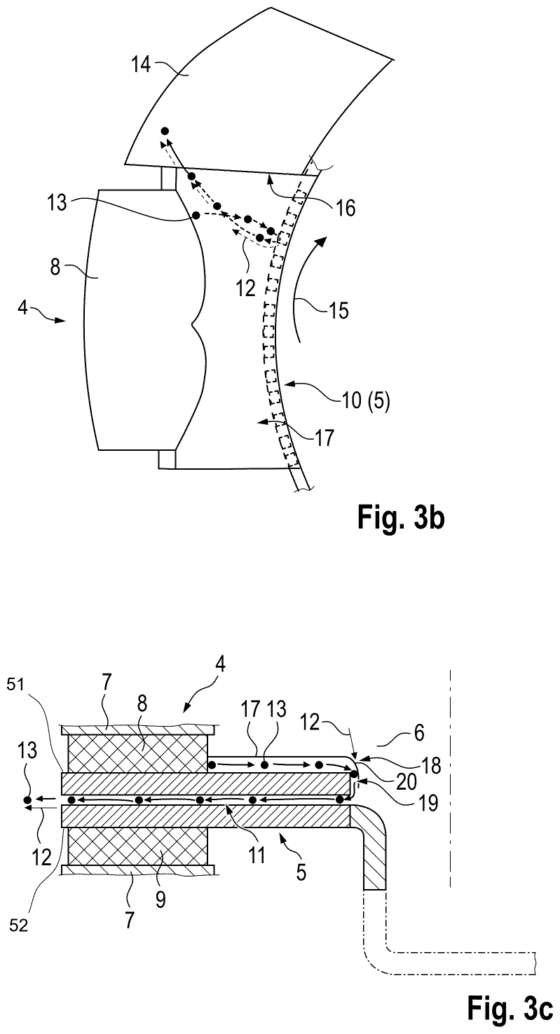

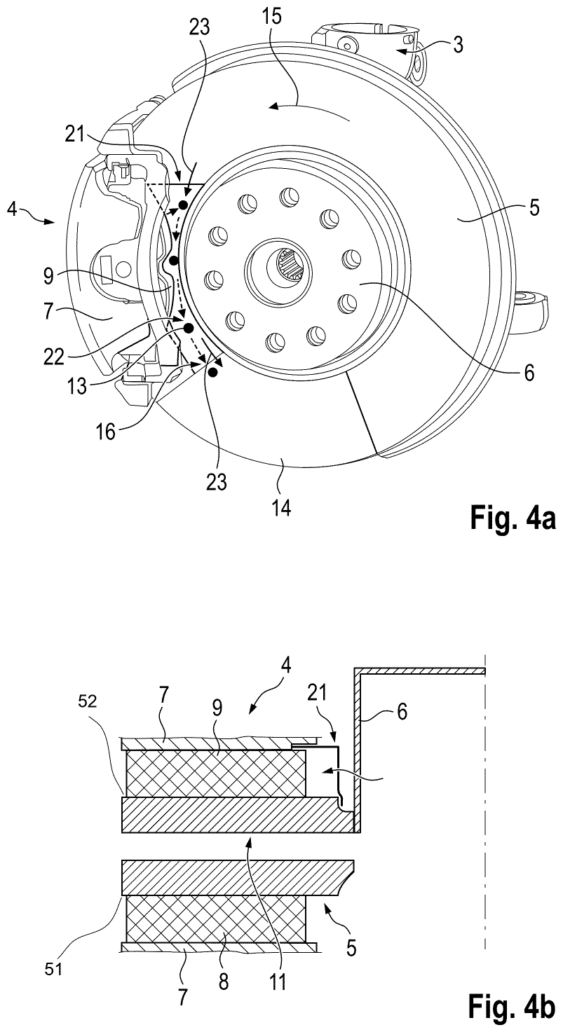

FIG. 1 shows a schematic representation of a vehicle 1, in the present example configured as a passenger car, which according to FIG. 2 comprises a wheel carrier 3 for each vehicle wheel 2, including a respective disk brake device 4. The disk brake device 4, on the one hand, comprises a brake disk 5, which is non-rotatably connected to the vehicle wheel 2 in question by means of a brake disk bell 6 formed or arranged on the brake disk on the radial inside. On the other hand, the disk brake device 4 comprises a brake caliper 57, which extends across the brake disk 5 on the radial outside and comprises a brake pad 8, 9 arranged on both sides of the brake disk 5 (refer, in particular, to FIGS. 3c, 4b). The brake caliper 7 is attached to the wheel carrier 3.

The brake disk 5 is a so-called internally vented brake disk 5, which is known per se and, on the vehicle side, radially on the inside, when installed, has a multitude of vent openings 10 that are distributed over the circumference of the brake disk 5 and that are connected, in terms of flow, to cooling channels 11 in the interior thereof (refer, in particular, to FIGS. 3c, 4b). During the function thereof, that is during a rotational movement of the vehicle wheel 2 and, accordingly, of the brake disk 5, the aforementioned cooling channels 11 guide air entering the vent openings 10, based on acting centrifugal forces, in the form of an air flow 12 radially outwardly out of the brake disk 5, whereby, as a result of friction forces, heat introduced into the brake disk 5 is effectively given off into the environment.

As was already described at the outset, a conventional brake application results in brake dust 13 (refer, in particular, to FIGS. 3b, 3c, 4a), being disadvantageously released into the environment or, as is shown in a highly schematic manner in FIGS. 3a, 3b, 4a. Here, brake dust may be collected, for example, in a brake dust filter housing 14, which is assigned to the disk brake device 4 and known per se. Viewed in a main direction of rotation 15 of the brake disk 5, the brake dust filter housing 14 is arranged downstream from the brake caliper 7, including the brake pads 8, 9, and encompasses the brake disk 5 on the radial outside in such a way that abraded brake dust 13 can be transported via a receiving opening 16 of the brake dust filter housing, which is oriented toward the brake caliper 7, into the housing. The aforementioned main direction of rotation 15 of the brake disk 5 shall be understood to mean the direction of rotation thereof which can be observed when the vehicle 1 is driving forward.

As was already explained or indicated above, there is a need to prevent the release of brake dust 13 into the environment to the greatest extent possible, at least however to minimize such release even more effectively in view of the prior art. So as to satisfy this concern, the disk brake device 4 comprises at least one means for the forced guidance of brake dust 13, wherein the aforementioned at least one means for forced guidance is used for example, in combination with the brake dust filter housing 13 according to the prior art.

In this regard, FIGS. 3a to 3c show a first variant embodiment, in which the means for forced guidance is formed by a guide plate 17. In this example, the guide plate 17 extends on the side of the vent openings 10 of the brake disk 5 between the brake pad in question, which here is the first brake pad 8, and the vent openings 10, and is furthermore, orthogonally spaced apart from the brake disk 5, connected to the first brake pad 8 and/or the brake caliper 7. As can furthermore be derived from FIG. 3c, the guide plate 17 extends so far into the region of the vent openings 10 that, proceeding from the aforementioned first brake pad 8 located opposite a first friction surface 51 of the brake disk 5, a defined flow path for the brake dust 14 through the vent openings 10 and cooling channels 11 of the brake disk 5 is formed, to the aforementioned receiving opening 16 of the brake dust filter housing 14 (refer to FIG. 3c).

As can furthermore be derived from FIG. 3c, the free end of the guide plate 17 for this purpose ends in the region of the vent openings 10 such that, in addition to the guidance of the brake dust 13 into the vent openings 10, the aforementioned air flow 12 from the outside into the vent openings 10 is ensured. This means that two flow channels 18, 19 that are separated from one another are created in the entrance region of the vent openings 10 by the free end of the guide plate 17, namely, on the one hand, for the aforementioned air flow 12 and, on the other hand, for the brake dust 13, the flow channels 18, 19 combining to form a guide channel or the aforementioned cooling channel 11 of the brake disk 5 in the immediate entrance region of the vent openings 10. So as to ensure reliable guidance, in particular of the brake dust 13 into the vent openings 10 of the brake disk 5, the guide plate 17 according to this exemplary embodiment, in the region of the aforementioned vent openings 10, comprises a deflection edge 20 that is bent toward the vent openings or the free end of the guide plate 17 forms the aforementioned deflection edge 20.

FIG. 3b shows the operating principle of the present disclosure in a schematic illustration. It is apparent that brake dust 13 is suctioned off or away from the brake pad 8 by means of the aforementioned air flow 12, acting as cooling air for the brake disk 5, and is forcibly guided, via the cooling channel 11 of the internally cooled brake disk 5, out of the same by way of centrifugal forces, into the brake dust filter housing 14.

So as to ensure particularly effective forced guidance of the brake dust 13, the guide plate 17, together with the components of the disk brake device 4 and of the brake dust filter housing 14 surrounding the same, forms a substantially sealed brake dust guidance and venting system, taking the rotating system of the disk brake device 4 or the rotating brake disk 5 into consideration. This results, for example, from the guide plate 17, on the edge side, comprising edge webs or bends that are brought close to the brake disk 5 (not shown in the drawings).

According to another example shown in FIGS. 4a and 4b, the means for forced guidance is formed by a brake dust guidance element 21, which, at least when installed, forms a housing and extends on the side of the brake disk 5 located opposite the vent openings 10 between the brake pad in question, which here is a second brake pad 9, and the radially inner brake disk bell 6 of the brake disk 5 and is connected to the second brake pad 9 located opposite a second friction surface 52 of the brake disk 5 and/or to the brake caliper 7, or is attached thereto. According to this example, the brake dust guidance element 21 is formed by a bent sheet, which together with the second brake pad 9 and the brake disk 5, viewed in the main direction of rotation 15 thereof, essentially forms a guide channel 22 for brake dust 13 to the receiving opening 16 of the brake dust filter housing 14. According to this exemplary embodiment, this formed guide channel 22 directly adjoins the aforementioned receiving opening 16.

FIG. 4a furthermore shows operating principles of a disk brake device in a schematic illustration. According to this figure, brake dust 13 is entrained in the main direction of rotation 15 of the brake disk 5 as a result of the rotational movement of the brake disk 5 and an air flow 23 generated thereby, and is transported into the brake dust filter housing 14.

In some examples, the disk brake device 4 may include both a guide plate 17 and a brake dust guidance element 21 of the type described above (not shown in the drawings). In this case, the guide plate 17 is arranged on the side of the vent openings 10 of the brake disk 5, while the aforementioned brake dust guidance element 21 is arranged on the opposite side of the brake disk 5.

The above-described exemplary embodiments are directed at an internally vented brake disk 5 including vent openings 10 and cooling channels 11. Alternatively, the aforementioned brake disk 5 can also be solid, that is, does not have such vent openings 10 and cooling channels 11. With respect to such solid brake disks 5, it shall be evident to a person skilled in the art that a means for the forced guidance of brake dust in the form of the above-described guide plate 17 can be dispensed with. In contrast, the means for the forced guidance of brake dust 13 here is exclusively formed by the above-described brake dust guidance element 21. For example, such a brake dust guidance element 21 is arranged on both sides of the solid brake disk 5, so as to particularly effectively prevent the release of brake dust into the environment, however to at least minimize the release more effectively than in the conventional manner. For the sake of simplicity, an illustration of this variant embodiment of the invention was dispensed with since this essentially corresponds to the illustration according to FIG. 4a.

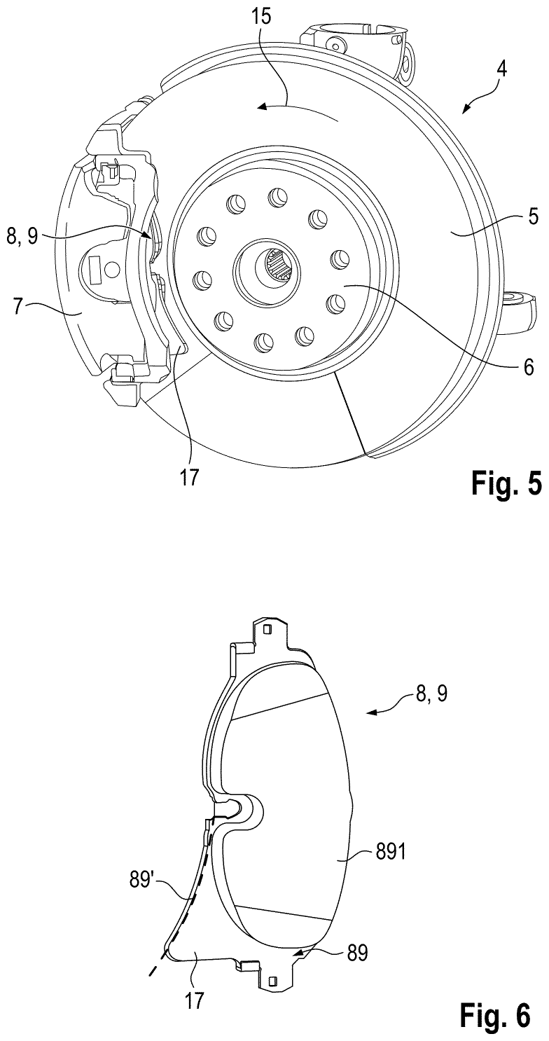

FIG. 5 shows the disk brake device 4 in other configurations according to some aspects of the present disclosure. In terms of function, reference is made to the above-described embodiments. The essential difference in this example is that the guide plate 17 for the forced guidance of brake dust is formed in one piece with a brake pad back plate 89 of the brake pad 8, 9 and, on the inner circumference, comprises a circular arc-shaped edge 89′. The curvature of the edge 89′ extends about the axial direction. This has the effect that the forced guidance of brake dust provided according to the invention can be implemented in a particularly cost-effective and simple manner. The costs for producing a brake pad 8, 9 thus modified hardly differ from those for producing a conventional brake pad.

A brake pad 8, 9 is illustrated in the example shown in FIG. 6. This brake pad comprises a friction lining 891, which is attached to a brake pad back plate 89. The brake pad back plate 89 is radially inwardly (with respect to an installation arrangement) extended, so as to form a guide plate 17 in one section. Alternatively (not shown in the figures), such a section forming the guide plate 17 can also be provided around the circumference on both sides at the brake pad back plate 89. The guide plate 17 formed by the brake pad back plate 89 comprises, on the inner circumference thereof, a circular arc-shaped edge 89′, having a curvature that corresponds to a radius of a predetermined brake disk bell.

### List of Reference Numerals

1 vehicle

2 vehicle wheel

3 wheel carrier

4 disk brake device

5 brake disk

51 first friction surface of the brake disk

52 second friction surface of the brake disk

6 brake disk bell

7 brake caliper

8 first brake pad

9 second brake pad

89 brake pad back plate

89′ circular arc-shaped edge

891 friction lining

10 vent opening

11 cooling channel

12 air flow

13 brake dust

14 brake dust filter housing

15 main direction of rotation

16 receiving opening (brake dust filter housing 14)

17 guide plate

18 flow channel

19 flow channel

20 deflection edge

21 brake dust guidance element

22 guide channel

23 air flow

1-24. (canceled)

25. A disk brake device for a vehicle, comprising:
a brake disk comprising a first axially oriented friction surface and a second axially oriented friction surface facing away from the first friction surface;
a brake caliper, extending across the brake disk and comprising a first brake pad configured to the first friction surface and a second brake pad configured to the second friction surface;
a brake dust filter housing, encompassing an outside radial of the brake disk, the brake dust filter housing comprising a receiving opening arranged downstream from the brake caliper configured in a direction of rotation of the brake disk;
at least one means configured for forced guidance of brake dust, the means for the forced guidance of brake dust being configured to extend from at least one of the first and second brake pads, radially inwardly over the respective friction surface of the brake disk, in the direction of an inner edge of the friction surface, such that brake dust, exiting radially inwardly between the at least one of the first and second brake pads and the brake disk is guided, along the respective friction surface along at least a partial flow path of the brake dust to the receiving opening of the brake dust filter housing.

26. The disk brake device according to claim 25, wherein the means for the forced guidance of brake dust extends radially inwardly over the respective friction surface of the brake disk to an inner edge of the respective friction surface.

27. The disk brake device according to claim 25, wherein the brake disk comprises an internally vented brake disk,
wherein the brake disk, on the vehicle side, comprising vent openings on a radial inside in the region of a brake disk bell, which is coupled to cooling channels in the interior of the brake disk,
and wherein the means for forced guidance comprises a guide plate, which extends radially along the first friction surface of the brake disk, at which the vent openings are configured, between the first brake pad and the vent openings and, spaced axially apart from the first friction surface of the brake disk, reaches a region of the vent openings in such a way that, a defined flow path for the brake dust is formed proceeding from the first brake pad, by way of the guide plate, through the vent openings and cooling channels of the brake disk, to the receiving opening of the brake dust filter housing.

28. The disk brake device according to claim 27, wherein the guide plate is configured to end in the region of the vent openings such that an air flow into the vent openings is ensured.

29. The disk brake device according to claim 27, wherein the guide plate, in the region of the vent openings, comprises a deflection edge that is bent toward the brake disk and guided around an inner edge of the first friction surface.

30. The disk brake device according to claim 27, wherein the guide plate is configured as a circular arc-shaped edge, at least partially on an inner circumference so as to follow a progression of the brake disk bell and the guide plate.

31. The disk brake device according to claim 27, wherein the guide plate, the brake caliper, and the brake disk, are configured as a substantially sealed brake dust guidance and venting system.

32. The disk brake device according to claim 27, wherein the first brake pad comprises a brake pad back plate, and the guide plate is fixedly connected to the brake pad back plate, and configured as one piece with the brake pad back plate of the first brake pad.

33. The disk brake device according to claim 27, wherein the guide plate is fixedly connected to the brake caliper.

34. The disk brake device according to claim 25, wherein the first brake pad comprises a friction lining, and the guide plate is fixedly connected to the friction lining.

35. The disk brake device according to claim 25, wherein the means for forced guidance comprises a brake dust guidance element, extending away from the second brake pad and in the direction of an inner edge of the second friction surface of the brake disk.

36. The disk brake device according to claim 25, wherein the means for forced guidance comprises a further brake dust guidance element, extending radially away from the first brake pad in the direction of an inner edge of the first friction surface of the brake disk.

37. The disk brake device according to claim 36, wherein the further brake dust guidance element extends on the first friction surface of the brake disk, radially away from the first brake pad to an inner edge of the first friction surface of the brake disk.

38. A brake pad for a disk brake device, comprising:
a brake pad back plate;
a friction lining attached to the brake pad back plate; and
a means for forced guidance of brake dust, the means for the forced guidance of brake dust being connected to the brake pad.

39. The brake pad according to claim 38, wherein the means for forced guidance for brake dust extends away from the friction lining in the radial direction, toward the inside of the brake pad.

40. The brake pad according to claim 38, wherein the means for the forced guidance of brake dust is configured as one piece with the brake pad back plate.

41. The brake pad according to claim 38, wherein the means for the forced guidance of brake dust is fixedly connected to the friction lining.

42. The brake pad according to claim 38, wherein the means for the forced guidance of brake dust comprises an edge that is configured, at least in sections, as a circular arc-shape on an inner circumference of the brake pad.

43. A motor vehicle, comprising:
a disk brake device of the motor vehicle, comprising:
a brake disk comprising a first axially oriented friction surface and a second axially oriented friction surface facing away from the first friction surface;
a brake caliper, extending across the brake disk and comprising a first brake pad configured to the first friction surface and a second brake pad configured to the second friction surface;
a brake dust filter housing, encompassing an outside radial of the brake disk, the brake dust filter housing comprising a receiving opening arranged downstream from the brake caliper configured in a direction of rotation of the brake disk;
at least one means configured for forced guidance of brake dust, the means for the forced guidance of brake dust being configured to extend from at least one of the first and second brake pads, radially inwardly over the respective friction surface of the brake disk, in the direction of an inner edge of the friction surface, such that brake dust, exiting radially inwardly between the at least one of the first and second brake pads and the brake disk is guided, along the respective friction surface along at least a partial flow path of the brake dust to the receiving opening of the brake dust filter housing.

44. The motor vehicle of claim 43, wherein the means for the forced guidance of brake dust extends radially inwardly over the respective friction surface of the brake disk to an inner edge of the respective friction surface.
